(19) United States
(12) Patent Application Publication
(10) Pub. No.: US 2006/0182939 A1
(43) Pub. Date: Aug. 17, 2006

(54) Method and arrangement forming a solder mask on a ceramic module

(75) Inventors: Vahid Goudarzi, Coral Springs, FL (US); Edwin L. Bradley, Coral Springs, FL (US); Kinzy Jones, Fort Lauderdale, FL (US); Gustavo D. Leizerovich, Aventura, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumburg, IL (US)

(21) Appl. No.: 11/056,529

(22) Filed: Feb. 11, 2005

(51) Int. Cl. B32B 18/00; C03B 29/00

(52) U.S. Cl. 428/210; 156/89.12; 29/851; 156/89.16

(57) ABSTRACT

A method (50) of forming a solder mask on a portion of a module (40) using for example LTCC technology includes the steps of forming (52) a multilayered ceramic substrate (20) with exposed metallization forming solder pads (28 or 31), masking (54 or 56) the solder pads by placing an additional ceramic layer (22 or 32) on the substrate that at least covers at least a portion of periphery of the solder pad using the LTCC process. The method can further include applying (58 or 60) solder (36) to a portion of the solder pad not covered by the solder mask (22) and placing a printed circuit board (34) having a different coefficient of thermal expansion than the multilayer ceramic substrate on the multilayer ceramic substrate to form the module before reflowing. The module can then be reflowed to form the module without cracks.

### FIELD OF THE INVENTION

This invention relates generally to solder masks, and more particularly to a method and system for forming a solder mask using a ceramic layer.

### BACKGROUND OF THE INVENTION

A low-temperature co-fired ceramic (LTCC) substrate is a ceramic that is fired at a relatively low temperature. It consists of a composite of alumina and quartz crystal with clad borosilicate as its base glass. It is used for forming the substrate of a multi-chip module, and offers the possibility of finer line widths for the ceramic substrate, and multilayer substrates at a lower cost, compared with the sequential screen printing method. LTCC substrates enable cost efficiency for high volumes, high packaging density with reliability, good dielectric thickness control, high print resolution of conductors, and low dielectric constant (K) dielectric material. LTCC substrates also allow for integrated and embedded passive components (capacitors, inductors, and resistors) in the LTCC substrate. The LTCC substrate is a small PCB made from multilayer ceramic dielectric tape and screen printing of conductors materials (silver and gold) on the green ceramic tape.

LTCC modules have a large CTE mismatch with the materials that are used to attach them to printed circuit boards or to materials used on components that might be placed on an LTCC module. As a result the solder pads that are used to attach to the PCB often can crack at the edges, causing electrical failures after reflow assembly, or smaller latent defects that can fail prematurely over time due to ceramic crack propagation. This problem is exacerbated by lead-free solder processes that raise the reflow assembly temperature and by larger integrated modules that result in greater stresses at the perimeter of the module.

### SUMMARY OF THE INVENTION

Embodiments in accordance with the present invention can form a solder mask by adding an additional ceramic layer using the LTCC process.

In a first embodiment of the present invention, a method of forming a solder mask on a portion of a module using for example low temperature co-fired ceramic (LTCC) technology can include the steps of stacking a plurality of ceramic layers where at least an external layer of the plurality of ceramic layers is patterned with metallization forming a solder pad, and placing an additional ceramic layer on the external layer that at least covers at least a portion of periphery of the solder pad. The method can further include the steps of laminating the plurality of ceramic layers and the additional ceramic layer, which can form a laminated stack, and heating the laminated stack to form a multilayer ceramic substrate having the solder mask. Note, the step of placing the additional ceramic layer can cover an entire periphery of the solder pad. Also note that placing the additional ceramic layer comprises placing the additional ceramic layer on at least one among a top surface or a bottom surface of the plurality of ceramic layers. The method can further include the step of applying solder to a portion of the solder pad not covered by the solder mask and placing a printed circuit board having a different coefficient of thermal expansion than the multilayer ceramic substrate on the multilayer ceramic substrate to form a module. The module can then be reflowed forming the module without cracks.

In a second embodiment of the present invention, another method of forming a module having a solder mask can include the steps of forming a plurality of ceramic layers having at least one externally exposed layer with metallization forming a solder pad, placing an additional ceramic layer on the external layer that at least covers at least a portion of periphery of the solder pad, and forming a multilayer ceramic substrate from the plurality of ceramic layers and the additional layer having the solder mask using low temperature co-fired ceramic technology. Note, the step of placing the additional ceramic layer can cover an entire periphery of the solder pad and the additional ceramic layer can be placed on either or both a top surface or a bottom surface of the plurality of ceramic layers. Also note that the method can further include the step of applying solder to a portion of the solder pad not covered by the solder mask. Optionally, the method includes the step of placing a printed circuit board having a different coefficient of thermal expansion than the multilayer ceramic substrate on the multilayer ceramic substrate to form a module. The module including the printed circuit board can be reflowed to form the module without cracks.

In a third embodiment of the present invention, a module having a solder mask can include a plurality of ceramic layers having at least one externally exposed layer with metallization forming a solder pad, an additional ceramic layer placed on the external layer covering at least a portion of periphery of the solder pad, and solder that only wets to an exposed portion of the solder pad. Note, the plurality of ceramic layers and the additional layer can form a multilayer ceramic substrate using low temperature co-fired ceramic technology where the additional ceramic layer covers a portion of a periphery or an entire periphery of the solder pad. The module can have at least one externally exposed layer with metallization on a top surface and at least one externally exposed layer with metallization on a bottom surface where the additional ceramic layer can be placed on either or both the top surface and the bottom surface of the plurality of ceramic layers. The module can further include a printed circuit board having a different coefficient of thermal expansion than the multilayer ceramic substrate. The printed circuit board and the multilayer ceramic substrate can be reflowed forming the module without cracks.

### BRIEF DESCRIPTION OF THE DRAWINGS

FIG. 1 is an illustration of an existing ceramic multilayer board formed using LTCC technology.

FIG. 2 is a side cut view of a multilayered ceramic module using an additional ceramic layer as a solder mask in accordance with an embodiment of the present invention.

FIG. 3 is a side cut view of a processed printed circuit board having solder placed on solder pads in accordance with an embodiment of the present invention.

FIG. 4 is a side cut view of the multilayered ceramic module of the FIG. 2 placed on the processed printed circuit board of FIG. 3 after being reflowed in accordance with an embodiment of the present invention.

FIG. 5 is a flow chart illustrating a method of forming a multilayered ceramic module having a masked solder pads in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

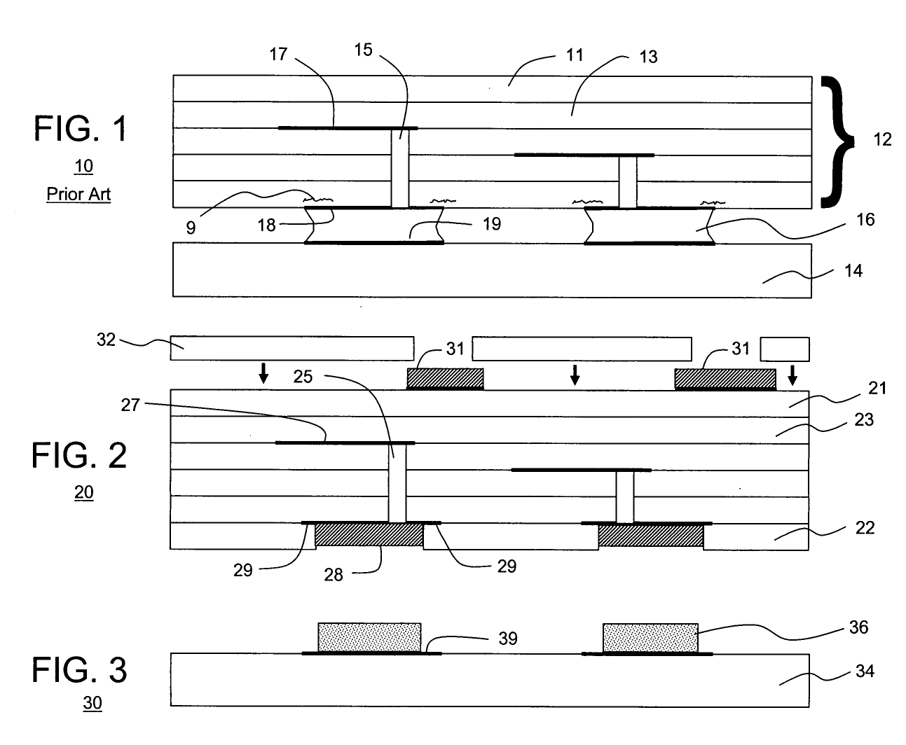

Before discussing embodiments of the present invention, a discussion with reference of how existing LTCC modules are formed using thin layers of ceramic will provide further clarification of the inventive aspects herein. Referring to FIG. 1, a multilayered ceramic module 10 including a multilayered ceramic board 12 soldered to a printed circuit board (PCB) 14 is shown. The board 12 can be formed from a plurality of ceramic layers 11, 13 stacked upon each other and laminated together. The board 12 can further include metallization 17 between ceramic layers, plated vias 15 and external metallization 18 forming solder pads. The metallization is typically silver and the external circuitry is then plated with nickel and gold so that it is solderable. These pads (18) are typically not masked off, and if they are masked they use secondary processes such as solder mask material or epoxy dam material. Solder 16 is placed between the solder pads (18) of the multilayered ceramic board 12 and solder pads 19 of the PCB 14. After or during a reflow process when placing the board 12 and PCB 14 through a reflow oven, cracks 9 typically form in one or more of, the ceramic layers 11, 13 of the multilayered ceramic board 12. Note, existing processes to resolve this cracking problem are more expensive and not a standard part of the LTCC manufacturing process. The use of epoxy dam material has a relatively high height and a large variability that cannot be well controlled, especially as the pad size is reduced. Using a PCB solder mask is comparable in thickness, but again is not a part of the LTCC process and is more expensive and not as robust as the embodiments of the present invention using a ceramic mask as will be described below. The ceramic mask in accordance with the embodiments herein is less expensive, more practical, and as effective as the existing processes described above.

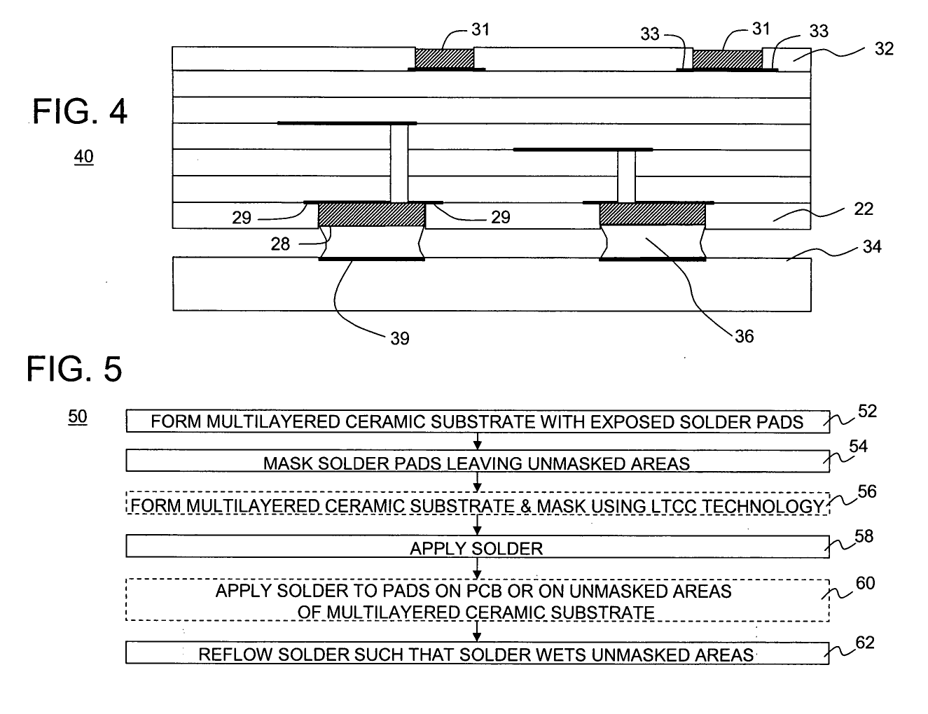

Referring to FIGS. 2-4, a process of forming a module 40 in accordance with an embodiment of the present invention is shown whereby an extra layer (22 and/or 32) of ceramic is added that acts as a solder mask by covering an edge (29 and/or 33) of solder pads (28 and/or 31 respectively) and preventing the solder from wetting those areas. The solder mask in the embodiments herein prevent the transfer of stress to the pad edge (particularly during cooling periods during or after reflow) which causes the problematic cracks 9 described with reference to the existing technology described with reference to FIG. 1. Again, the module 40 can be formed using the LTCC process from a multilayered ceramic board 20 having a plurality of ceramic layers 21, 23 stacked upon each other and laminated. The board 20 can include metallization 27 between ceramic layers, plated vias 25 and external metallization forming solder pads 28 and/or 31. Solder pads 28 can be formed on a bottom surface of the board 20 and solder pads 31 can be formed on a top surface of the board 20. The multilayered ceramic board 20 can then further include at least one additional ceramic layer 22 and/or 32 to serve as a solder mask covering at least a portion 29 and/or 33 of a periphery of the solder pads 28 and/or 31 respectively. The portion 29 or 33 can be an edge of the solder pads or can include an entire periphery of the solder pads. Note, as shown in FIG. 2, the additional ceramic layer 22 is shown already in a laminated and compressed state forcing the solder pad 28 to conform to the shape of the mask defined by the additional ceramic layer 22 and masking the edge or portions 29 of the metallization or solder pad 28. The additional ceramic layer 32 is optionally shown in FIG. 2 on a top surface of the board 20, but before layer 32 would be laminated to the remainder of the board 20 and masking the edges or portions (33, see FIG. 4) of the solder pads 31 on the top surface. In this regard, the solder pad 31 is shown in FIG. 2 in an unconformed state as opposed to the conformed state shown in FIG. 4 where edges or portions 33 of the solder pads 31 are masked by the additional ceramic layer 32.

Referring to FIG. 3, a PCB 34 can include metallization such as solder pads 39. Solder 36 can be applied in any manner such as screen printing to the solder pads 39 to form the processed PCB 30 which can be coupled to the masked multilayered ceramic board 20 of FIG. 2 to form the module 40 as shown in FIG. 4. As shown in FIGS. 2 and 4, the additional ceramic layer 22 can conveniently mask the edges 29 of the solder pad 28 using the LTCC process so that solder only wets to an exposed portion of the solder pad 28 during a reflow process. Note, as previously discussed the module 40 can optionally have at least one externally exposed layer with metallization or solder pads 31 on the top surface which is masked using the additional ceramic layer 32. Solder pads 31 can be used to connect to other components (not shown) on the top surface of the module 40. Further note, the printed circuit board 34 can have a different coefficient of thermal expansion than the multilayer ceramic substrate 20 placed on or coupled to the printed circuit board 34. As shown in FIG. 4, the printed circuit board 34 and the multilayer ceramic substrate can be reflowed forming the module 40 without cracks.

Referring to FIG. 5, flow chart illustrating a method 50 of forming a solder mask on a portion of a module using for example low temperature co-fired ceramic (LTCC) technology is shown. The method 50 can include the step 52 of forming a multilayered ceramic substrate with exposed solder pads by stacking a plurality of ceramic layers where at least an external layer of the plurality of ceramic layers is patterned with metallization forming the solder pad. The method 50 can further include the step 54 of masking the solder pads and leaving unmasked areas. The masking step can optionally be done in step 56 by placing an additional ceramic layer on the external layer that at least covers at least a portion of periphery or edge of the solder pad using the LTCC technology. The LTCC technology can further include the steps of laminating the plurality of ceramic layers and the additional ceramic layer forming a laminated stack, and heating the laminated stack to form a multilayer ceramic substrate having the solder mask. Note, the step of placing the additional ceramic layer can cover an entire periphery of the solder pad rather than just a portion of the periphery. Also note that placing the additional ceramic layer comprises placing the additional ceramic layer on at least one among a top surface or a bottom surface of the plurality of ceramic layers. The method can further include the step of applying solder at step 58 or 60 to a portion of the solder pad not covered by the solder mask and placing a printed circuit board having a different coefficient of thermal expansion than the multilayer ceramic substrate on the multilayer ceramic substrate to form a module. The module can then be reflowed at step 62 such that the solder only wets the unmasked areas and the module is formed without cracks.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of forming a solder mask on a portion of a module, comprising the steps of:
stacking a plurality of ceramic layers, wherein at least an external layer of the plurality of ceramic layers is patterned with metallization forming a solder pad;
placing an additional ceramic layer on the external layer that at least covers at least a portion of periphery of the solder pad;
laminating the plurality of ceramic layers and the additional ceramic layer forming a laminated stack; and
heating the laminated stack to form a multilayer ceramic substrate having the solder mask.

2. The method of claim 1, wherein the step of placing the additional ceramic layer covers an entire periphery of the solder pad.

3. The method of claim 1, wherein the method further comprises the step of applying solder to a portion of the solder pad not covered by the solder mask.

4. The method of claim 1, wherein the step of placing the additional ceramic layer comprises placing the additional ceramic layer on at least one among a top surface or a bottom surface of the plurality of ceramic layers.

5. The method of claim 3, wherein a printed circuit board having a different coefficient of thermal expansion than the multilayer ceramic substrate is placed on the multilayer ceramic substrate to form a module.

6. The method of claim 5, wherein the module is reflowed forming the module without cracks.

7. The method of claim 1, wherein the method of forming the solder mask on the portion of the module is done using low temperature co-fired ceramic technology.

8. A method of forming a module having a solder mask, comprising the steps of:
forming a plurality of ceramic layers having at least one externally exposed layer with metallization forming a solder pad;
placing an additional ceramic layer on the external layer that at least covers at least a portion of periphery of the solder pad; and
forming a multilayer ceramic substrate from the plurality of ceramic layers and the additional layer having the solder mask using low temperature co-fired ceramic technology.

9. The method of claim 8, wherein the step of placing the additional ceramic layer covers an entire periphery of the solder pad.

10. The method of claim 8, wherein the method further comprises the step of applying solder to a portion of the solder pad not covered by the solder mask.

11. The method of claim 10, wherein a printed circuit board having a different coefficient of thermal expansion than the multilayer ceramic substrate is placed on the multilayer ceramic substrate to form a module.

12. The method of claim 11, wherein the module is reflowed forming the module without cracks.

13. The method of claim 8, wherein the step of placing the additional ceramic layer comprises placing the additional ceramic layer on at least one among a top surface or a bottom surface of the plurality of ceramic layers.

14. A module having a solder mask, comprising:
a plurality of ceramic layers having at least one externally exposed layer with metallization forming a solder pad;
an additional ceramic layer placed on the external layer covering at least a portion of periphery of the solder pad; and
solder that only wets to an exposed portion of the solder pad.

15. The module of claim 14, wherein the plurality of ceramic layers and the additional layer form a multilayer ceramic substrate using low temperature co-fired ceramic technology.

16. The module of claim 14, wherein the additional ceramic layer covers an entire periphery of the solder pad.

17. The module of claim 15, wherein the module further comprises a printed circuit board having a different coefficient of thermal expansion than the multilayer ceramic substrate.

18. The module of claim 17, wherein the printed circuit board and the multilayer ceramic substrate are reflowed forming the module without cracks.

19. The module of claim 14, wherein the module comprises at least one externally exposed layer with metallization on a top surface and at least one externally exposed layer with metallization on a bottom surface and the additional ceramic layer placed on at least one among the top surface and the bottom surface of the plurality of ceramic layers.
